(19) United States
(12) Patent Application Publication
(10) Pub. No.: US 2009/0013781 A1
(43) Pub. Date: Jan. 15, 2009

(54) Method and device to measure the level of pressurized liquid in a siphon container

(76) Inventor: Jaring M. Hettinga, Campbellville (CA)

Correspondence Address: JARING M. HETTINGA;c/o TYLON, P.O.Box 154, CAMPBELLVILLE, ON, L0P 1B0, CA

(21) Appl. No.: 11/826,230

(22) Filed: Jul. 13, 2007

(51) Int. Cl. G01F 23/02

(52) U.S. Cl. 73/323; 73/299

(57) ABSTRACT

A method and device which provides visual means to confirm the level of liquid in an opaque container, by operating an adjacent transparent gauge tube which is in correspondence with the liquid on the inside of container, notwithstanding the pressurized condition of the liquid, while maintaining the pressure above the liquid in the gauge tube at the same level as the pressure above the liquid in the container.

CIP of Provisional Application No. 60/701,514, dated Jul. 13, 2007

### BACKGROUND OF THE INVENTION

All bar or restaurant owners have a problem monitoring the amount of beer remaining in a beer keg or being dispensed by a bartender, without some form of metering device.

The owner firstly depends upon the distributor to deliver a full keg of beer. The owner may then incur various losses when tapping the keg and when beer is dispensed. He assumes that each mug of beer that is filled, contains the correct number of ounces, and he further assumes that the bartender collects the correct amount of money for every mug poured.

Each part of this process has inherent difficulties and contributes to a possible loss of income to the restaurant owner. Adding up all the various possible losses, the restaurant owner can expect to waste about 15 percent of his profits. This profit loss is presently commercially undetectable, and is usually absorbed by the restaurant owner.

It is therefore desired to obtain a visual indication of the level of liquid in a container of opaque material such as wood, metal or the like. This may be accomplished by means of a separate vertically extended tube or sight gauge, preferably of transparent material such as glass or plastic, provided with suitable calibrated gradations. The lower end of the tube is connected in communication with the liquid in the container so that the liquid level in the tube and the container will remain the same when the pressure, which may be atmospheric pressure, on the surface of the liquid in the container and the tube is the same. In light of this, as liquid is removed from the container, the level of the liquid in the tube will follow exactly the level of liquid in the container. This then provides a constant indicator of the exact level of liquid in the container.

There is therefore a need for a corresponding gauge which could be used specifically with liquid dispensed from a pressurized siphon container.

In U.S. Pat. No. 5,007,560, Sassak discloses a beer dispensing and monitoring method and apparatus, which delivers beer to a valve that is opened to dispense a predetermined weight of the beverage by monitoring the stages of reduced weight of the supply keg.

This does not provide the constant visual demonstration and representation of the actual level of liquid or beer contained in the beer keg, as is provided in the present invention.

In U.S. Pat. No. 5,343,743, Chapman discloses an asymmetrical displacement flowmeter which is an invention also contrary to the invention described in this disclosure.

### SUMMARY OF THE INVENTION

In view of the preceding, the invention disclosed herein provides a liquid level indicator adjacent a pressurized siphon container such as a beer keg or the like, in which the liquid is maintained under pressure for the purpose of periodic dispensing through the dispensing conduit. The invention can easily be operated when said indicator is attached to the side of the container to be measured, or is located even at a remote location.

### BRIEF DESCRIPTION OF THE DRAWING

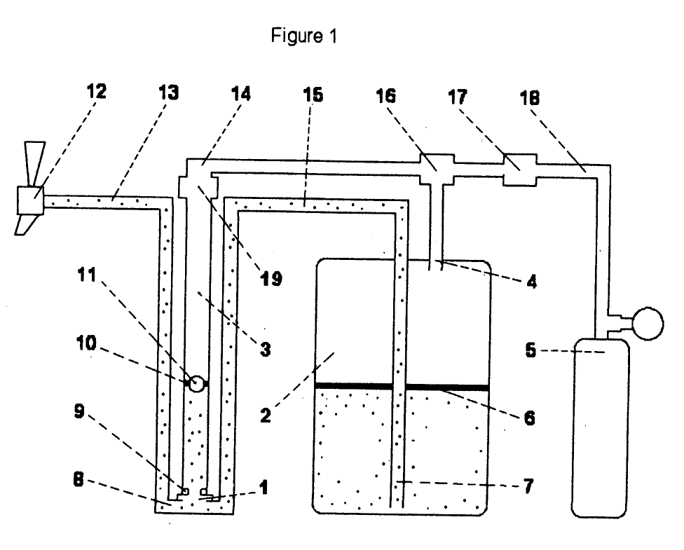

The invention will now be described in detail, by way of example only, with reference to accompanying FIG. 1, which is a schematic illustration of the invention in conjunction with the layout of a pressurized siphon container.

### DETAILED DESCRIPTION

The objectives of the invention are accomplished by the provision of a gauge tube 3, extending vertically and having an upper end 14 in communication with the interior of the container 2 and an associated source of pressurized gas 5 and a lower end 8 in communication with the container outlet 7 and the point of use 12 at a remote location by means of independent conduits 13, 15 which are vertically extended upwards. The gauge tube in the preferred embodiment is transparent or translucent, but could be colored if desired. Alternatively, the tube could be opaque, with other means used to detect the fluid level in the tube, such as an ultrasonic transmitter and transducer, for example.

A floating ball check valve 11 is contained within the gauge tube 3 for the purpose of preventing any flow of pressurized gas introduced into the tube upper end 14 from reaching beyond the lower end 8 of the gauge tube during dispensing whereby the liquid level 10 and the floating ball 11 in the tube drops only to the lower end 8 of the gauge tube 3 during dispensing and immediately returns to the new liquid level of the container upon termination of such dispensing.

This is accomplished by having the valve seat 9 at the lower end 8 of the gauge tube 3, at or below the empty level measurement, and the floating ball 11 having freedom of movement within the gauge tube 3 making the gauge tube 3 the actual valve body. A second or more tube may be added vertically beside or at a remote location to the actual gauge tube and put in direct communication by means of independent conduit with the upper and lower ends 14, 8 of the gauge tube and also give the same level indication as the gauge tube. For simplicity, floating valve sealing member 11 is described as a ball.

Other float valve configurations can be used, such as conical or elliptical, as well as other forms of valves, to suit particular liquid system requirements. Also either a manual or electrically controlled three-way valve 16, 1 can be incorporated into either the pressurized gas upper end 14 or the liquid flow lower end 8 or both of the gauge tube 3 to prevent the complete or partial ejection of the liquid from the gauge tube 3 under the force of the pressurized gas 5 being introduced into the top of the gauge tube 14 and the resultant presence of gas in the dispensing conduit 13. The three-way valve or valves 16, 1 would, in the first position, facilitate communication with the upper end 14 of the gauge tube 3 and the pressurized gas 5 in the container 2 and the lower end 8 of the gauge tube 3 and the liquid 6 in the container 2 in order to read the level of the liquid in the gauge tube 10.

In the second position, the valve or valves would facilitate communication between the associated pressurized gas source 5 and the gas inlet 4 of the container and also the liquid outlet of the container 7 and the point of use at a remote location 12 in order to dispense the liquid from the container 2 and prevent the ejection of the liquid from the gauge tube 3. A shut-off valve or valves 16, 1 being manual or electrically controlled can be placed at either the upper end 14 or lower end 8 or both of the gauge tube 3 in order to facilitate normal dispensing from the container 2 whereby when either one or both of the shut-off valves is closed with out the ejection of the liquid from the gauge tube lower end 8 under the force of the pressurized gas 5 being introduced into the upper end 14 of the gauge tube 3 and the resultant presence of the pressurized gas in the dispensing conduit 13.

Subsequently, the shut-off valve or valves 16, 1 would facilitate communication between the upper end of the gauge tube 14 and the associated pressurized gas source 5 and the pressurized gas in the container 4 as well as communication between the lower end of the gauge tube 8 and the liquid outlet of the container 7 and the point of use at a remote location 12 in order to accurately read the level of liquid in the gauge tube 10 and ultimately the container 6 only when the valve or valves are in the open position and no dispensing of the liquid is taking place.

Also a rapid gas flow preventing check valve 19 could be incorporated within the gauge tube upper end 14 to prevent the rapid flow of pressurized gas 5 into the gauge tube 3 and subsequent ejection of the liquid from the gauge tube 3 and dispensing conduit 13 during periodic or constant dispensing of the liquid in the container 2. This rapid gas flow check valve 19 would, when calibrated to pressure of the associated source of pressurized gas 5 used for dispensing the liquid, facilitate an accurate read in the gauge tube 3 of the level of the liquid in the container 6 at all times and be unaffected by the periodic or constant dispensing of the liquid from the container 2.

With this configuration, the level of liquid in the gauge tube corresponds to the level of liquid in the pressurized siphon container, notwithstanding the pressurization, because the pressure above the liquid in the gauge tube is the same as the pressure above the liquid in the container,

I herewith claim the following:

1. A method for determining and indicating the level of a pressurized liquid contained in a siphon container, comprising:
a) operating a transparent or translucent gauge tube vertically placed adjacent the siphon container;
b) keeping said gauge tube filled with liquid from the siphon container by having the lower end of the gauge tube communicating with a liquid dispensing conduit connected to said siphon container;
c) keeping the level of liquid in said gauge tube equal with the level of liquid in the siphon by having the upper end of the gauge tube communicating with an upper portion of the interior of the container such as to maintain a pressure condition in said gauge tube equal to the pressure condition in the siphon container;
d) operating a check valve in said gauge tube such as to prevent pressurizing gas from escaping said gauge tube into said dispensing conduit.

2. A method according to claim 1, wherein the pressurized liquid is beer.

3. A device for determining and indicating the level of a pressurized liquid contained in a siphon container, comprising:
a) a transparent or translucent gauge tube vertically placed adjacent the siphon container;
b) a gauge tube which is in communication with the liquid in the siphon container by having its lower end attached to a liquid dispensing conduit connected to said siphon container;
c) a gauge tube in which the level of liquid is kept equal with the level of liquid in the siphon by having the upper end of the gauge tube communicating with an upper portion of the interior of the container such as to maintain a pressure condition in said gauge tube equal to the pressure condition in the container;
d) a check valve in said gauge tube which operates such as to prevent pressurizing gas from escaping said gauge tube into said dispensing conduit.

4. A device according to claim 3, wherein the pressurized liquid is beer.
